(19) United States
(12) Patent Application Publication
(10) Pub. No.: US 2007/0109765 A1
(43) Pub. Date: May 17, 2007

(54) Bottom lighting type backlight module

(75) Inventors: Shao-Hang Chang, Tu-cheng (TW); Fen Chen, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/501,941

(22) Filed: Aug. 10, 2006

(30) Foreign Application Priority Data
Nov. 11, 2005 (TW) 94139712

(51) Int. Cl. G09F 13/04

(52) U.S. Cl. 362/97

(57) ABSTRACT

A bottom lighting type backlight module includes a frame, a plurality of light sources, a reflecting sheet and one optical sheet. The frame includes a base and a plurality of sidewalls extending from the peripheral of the base to define an opening. The base defines a plurality of guide holes therein. The optical sheet is disposed on the opening of the frame. The optical sheet and the frame collectively define a chamber. The reflecting sheet is supported by the sidewalls, for partitioning the chamber into an illumination space and a heat dissipation space. The reflecting sheet defines a plurality of through holes therein. The light sources are arranged on the base of the frame under the reflecting sheet according to the through holes, illuminating light through the through holes towards the optical sheet. The present backlight module has a thin body with good heat dissipation capability.

### TECHNICAL FIELD

The present invention relates to backlight module, more particularly, to a bottom lighting type backlight module for use in, for example, a liquid crystal display (LCD).

### BACKGROUND

Most LCD devices are passive devices in which images are displayed by controlling an amount of light input from an outside light source. Thus, a separate light source (for example, backlight module) is generally employed for illuminating an LCD.

Generally, backlight module can be classified into an edge lighting type or a bottom lighting type based upon the location of lamps within the device. The edge lighting type backlight module has a lamp unit arranged at a side portion of a light guiding plate for guiding light. The edge lighting type backlight modules are commonly employed in small-sized LCD due to their lightweight, small size, and low electric consumption. However, the edge lighting type backlight modules are not suitable for large-sized LCD (20 inches or more). A bottom lighting type backlight module has a plurality of lamps arranged in regular positions to directly illuminate an entire surface of an LCD panel. The bottom lighting type backlight modules have higher efficiency of light usage and longer operational lifetime than the edge lighting type backlight modules, the bottom lighting type backlight modules are especially used in large-sized LCD devices. However, an LCD device usually employs a significant amount of lamps to reach a high luminance. The significant amount of lamps results in a great deal of heat produced and cumulated inside the LCD device. Therefore, heat dissipation of the direct type backlight modules is usually a hard nut to crack.

Referring to FIG. 5, a typical bottom-lighting backlight module 30 is shown. The backlight module 30 includes a frame 31, a heat dissipation panel 32, a plurality of optical sheets 33, a plurality of light emitting diodes 34 and a reflecting unit 35. The frame 31 is a rectangular-shaped housing having four connecting sidewalls (not labeled). The heat dissipation panel 32 is mounted into a bottom of the sidewalls of the frame 31. Accordingly, the heat dissipation panel 32 and the frame 31 collectively define a chamber (not labeled) thereby. The heat dissipation panel 32 includes a rectangular base 321 shaped corresponding to the frame 31 and a plurality of fins 322 extending out from a bottom surface of the base 321 perpendicularly.

The optical sheets 33 are layered on a top of the sidewalls of the frame 31 facing the base 321. The light emitting diodes 34 are aligned on an upper surface of the base of the heat dissipation panel 32 facing the optical sheets 33. The reflecting unit 35 defines a plurality of holes (not labeled) therein according to the light emitting diodes 34. The reflecting unit 35 is disposed on the base 321 of the heat dissipation panel 32. The reflecting unit 35 further defines a plurality of holes exposing the light emitting diodes 34 to emit light rays to enter the optical sheets 33 through the holes thereof. The base 321 of the heat dissipation panel 32 is usually formed of materials with a high heat conductive coefficient. This is because the base 321 is in direct contact with the light emitting diodes 34, a great deal of heat produced by the. light emitting diodes 34 can be directly dissipated out through the base 321 and the fins 322.

As described the components of the backlight module 30 are plentiful, thus assembling the backlight module is complicated and difficult. In addition, the thickness of the backlight module 30 is limited due to the physical properties of the heat dissipation panel 32. Furthermore, the heat dissipation panel 32 commonly needs an auxiliary device such as a fan, to increase its heat dissipation efficiency. If, however, an air-cooling fan is used, dust is whirled up to adhere to the surface of light emitting diodes 33 or to the optical sheets 33 disposed thereon, thus deteriorating the uniformity of brightness of the backlight module 30. Furthermore, a noise produced by the fan is also a shortcoming.

What is needed, therefore, is a bottom lighting type backlight module that overcome the above mentioned shortcomings.

### SUMMARY

A bottom lighting type backlight module according to a preferred embodiment includes a frame, a plurality of light sources, a reflecting sheet and at least one optical sheet. The frame includes a base and a plurality of sidewalls extending from the peripheral of the base to define an opening. The base defines a plurality of guide holes therein. The optical sheet is disposed on the opening of the frame, the optical sheet and the frame collectively defining a chamber. The reflecting sheet is supported by the sidewalls, for partitioning the chamber into an illumination space and a heat dissipation space, above and below the reflective sheet respectively. The reflecting sheet defines a plurality of through holes therein. The light sources are arranged on the base of the frame under the reflecting sheet according to the through holes, illuminating light through the through holes towards the optical sheet.

Other advantages and novel features will become more apparent from the following detailed description of the preferred embodiments, when taken in conjunction with the accompanying drawings.

### BRIEF DESCRIPTION OF THE DRAWINGS

Many aspects of the present bottom lighting type backlight module can be better understood with reference to the following drawings. The components in the drawings are not necessarily drawn to scale, the emphasis instead being placed upon clearly illustrating the principles of the present bottom lighting type backlight module. Moreover, in the drawings, like reference numerals designate corresponding parts throughout the several views.

FIG. 1 is a schematic, exploded perspective view of a bottom lighting type backlight module according to a preferred embodiment;

FIG. 2 is a schematic, enlarged, assembled perspective view of the bottom lighting type backlight module of FIG. 1;

FIG. 3 is a schematic, perspective view taken along a III-III line of FIG. 1;

FIG. 4 is a schematic, perspective view of the bottom lighting type backlight module of FIG. 3 without assembling an optical sheet and a reflecting sheet; and

FIG. 5 is a schematic, cross-sectional view of a conventional bottom lighting type backlight module.

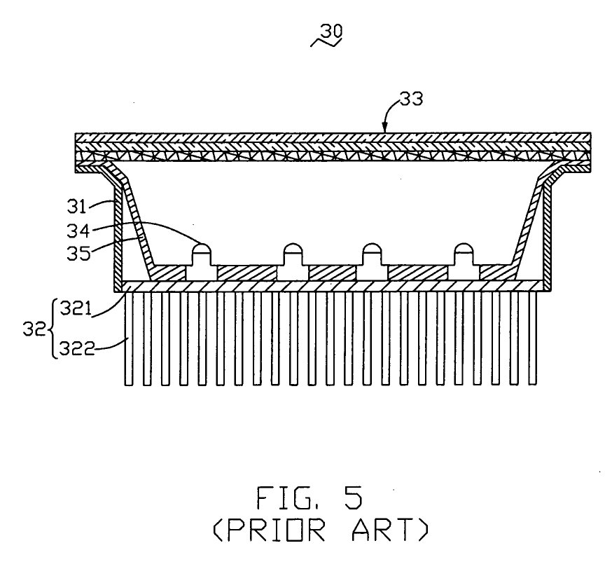

### DETAILED DESCRIPTION OF THE PREFERRED EMBODIMENTS

Reference will now be made to the drawings to describe preferred embodiments of the present bottom lighting type backlight module, in detail.

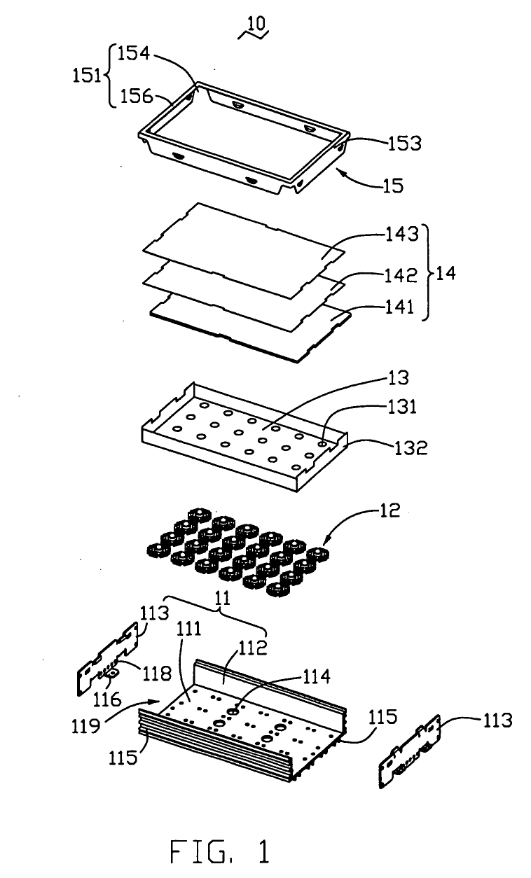

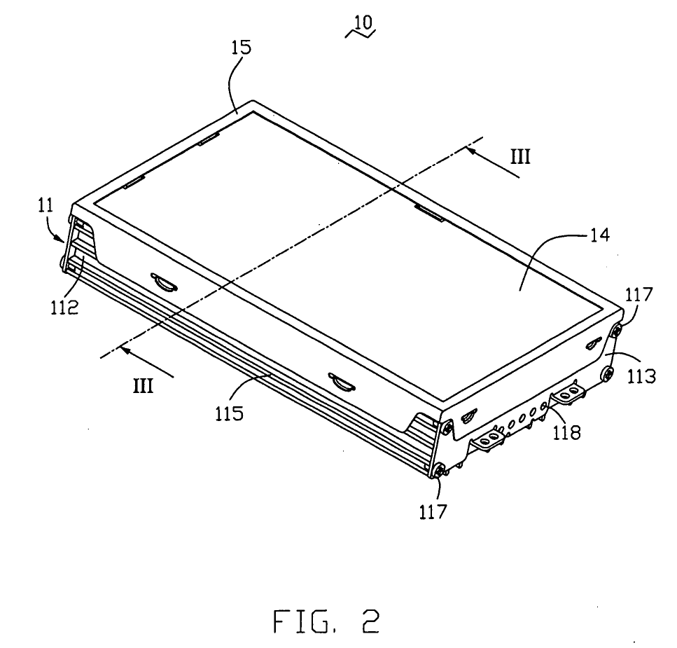

Referring to FIGS. 1 and 2, a bottom lighting type backlight module 10 in accordance with a preferred embodiment is shown. The bottom lighting type backlight module 10 includes a frame 11, a plurality of light emitting diodes 12, a reflecting sheet 13, and three optical sheets 14. The frame 11 is a rectangular-shaped housing. The frame 11 includes a base 111, two first sidewalls 112, and two second sidewalls 113. Each of the two first sidewalls 112 correspondingly extends from two opposite edges of the base 111. The first sidewalls 112 and the base 111 may be integrally manufactured by pressing a metal board (not shown). Each second sidewall 113 is substantially in the form of a rectangular sheet, which defines a protrusion portion 116 extending from a portion beyond the bottom thereof toward an inner area of the frame 11. The two second sidewalls 113 are securely connected with the ends of the two first sidewalls 112 and the base 111 by a number of screws 117. The first and second sidewalls 112 and 113, and the base 111 collectively define an opening 119. The base 111 defines a plurality of first guide holes 114 therein in a matrix manner, and the second sidewalls 113 also defines a plurality of second guide holes 118 therein above the protrusion portion 116 correspondingly. A plurality of fins 115 extends out from outer surfaces of the first sidewalls 112 and bottom surface of the base 111, parallel to each other.

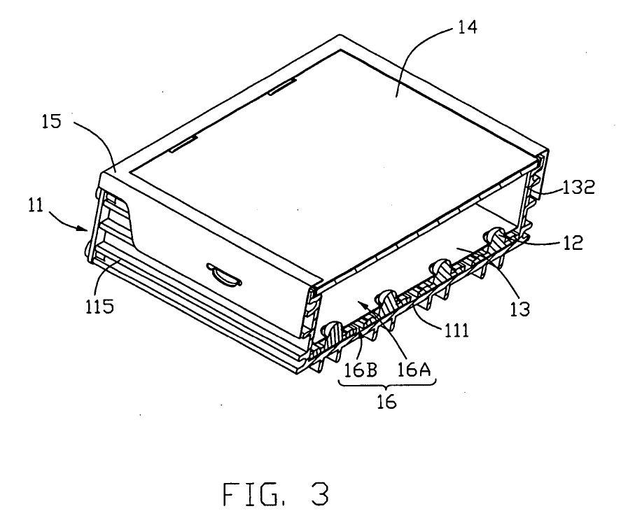

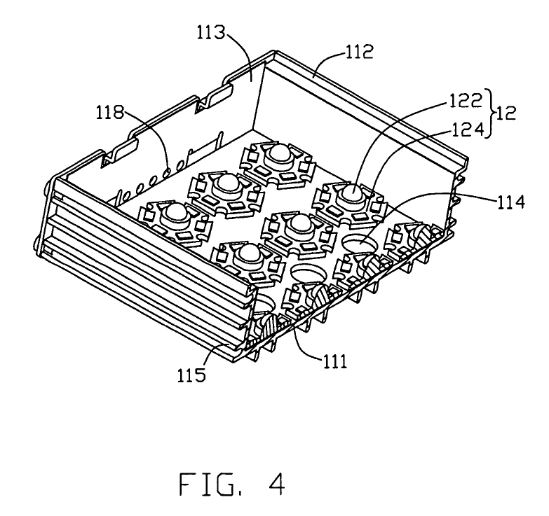

The three optical sheets 14 include a light diffusion plate 141, a prism sheet 142, and a bright enhancement film 143 are stacked on the opening 119 of the frame 11 in that order. Referring to FIGS. 3 and 4, the optical sheets 14 and the frame 11 collectively define a chamber 16. The light emitting diodes 12 are attached to the base of the frame in a matrix manner. The reflecting sheet 13 is supported by the protrusions 116 of the second sidewalls 113, for partitioning the chamber 16 into an illumination space 16A and a heat dissipation space 16B, above and below the reflecting sheet 13 respectively. The reflecting sheet 13 defines a plurality of through holes 131 therein corresponding to the light emitting diodes 12.

Each light emitting diode 12 includes a substrate 124 and a light luminescent top portion 122 disposed on the substrate. When the light luminescent top portion 122 emits light, the substrate 124 generates heat. The substrate 124 of each light emitting diode 12 is attached to the base 111 of the frame 11 by a plurality of screws (not shown) in the heat dissipation space 16B. The light luminescent top portion 122 of each light emitting diode 12 passes through the through holes 131 of the reflecting sheet 13 and exposes in the illumination space 16A, thus radiating light toward the optical sheets 14 directly.

In this embodiment, the backlight module 10 may further include four reflecting sidewalls 132 extending from the periphery of the reflecting sheet 13. Tops of the four reflecting sidewalls 132 are in contact with the optical sheets 14. The reflecting sidewalls 132 are used for reflecting light back to the optical sheets 14 to improve a light energy utilization rate. The frame 11 may be formed of materials with a high heat conductive coefficient such as metal or engineering plastic. The metal may be preferably selected from copper or aluminum.

In this embodiment, the backlight module 10 may further include an upper frame 15 for fixing the three optical sheets 14 tightly. The upper frame 15 includes an upper base 151 and four upper sidewalls 153 extending perpendicularly from the upper base 151 correspondingly. The upper base 151 defines an opening 154 in the interior thereof and forms four frame edges 156. The optical sheets 14 are exposed through the opening 154 of the upper base 151. Each upper sidewalls 153 of the upper frame 15 and the second sidewalls 113 of the main frame 41 correspondingly define a plurality of locking elements (not labeled) thereon, thus the upper frame 15 and the frame 11 could be assembled together thereat to fix the three optical sheets 14 tightly.

As described above, in the present embodiment, the closed illumination space 16A is formed between the optical sheets 14 and the reflecting sheet 13 installed in the chamber 16, the light luminescent top portions 122 of light emitting diodes 12 are housed therein. The open heat dissipation space 16B is formed between the reflecting sheet 13 and the base 111 of the frame 11. Furthermore, it is impossible that dust and dirt fed in together with the cooling air that enters the illumination space 16A, thus preventing dust and dirt from adhering the optical sheets 14. In addition, because the light emitting diodes 12 are in contact with the base 111 of the heat dissipation space 16B, the heat generated from the light emitting diodes 12 is substantially accumulated within the heat dissipation space 16B. Therefore, a shape of the optical sheets 13 may not be easily deformed due to the temperature change. Furthermore, cooling air may be forcibly fed through the first guide holes 114 and the second guide holes 118 by an external air-cooling fan (not shown) or the like. Since the cooling air moves along the surfaces of light emitting diodes 12 and the base 111 of the frame 11, it becomes possible to diffuse the heat generated from the light emitting diodes 12 outward very efficiently. The fins 115 of the base 111 and the first sidewalls 112 could also help to improve the backlight module 10's heat dissipation capabilities.

In alternative embodiments, the present backlight module may further include a receiving frame and a transparent supporting plate. The receiving frame includes a frame body, a rim portion extending from a bottom of the frame body running perpendicularly around an inside of the receiving frame. The receiving frame may be fixed at the top of the frame, the rim portion thereof being used to receiving the optical sheets. The transparent supporting plate defines a plurality of holes therein corresponding to the through holes of the reflecting sheet. The supporting plate may be fixed on the protrusions of the second sidewalls of the frame, being used to support the reflecting sheet.

It is to be understood that the present backlight module not only may employ a combination of the optical sheets, but also may employ one optical sheet, such as a light diffusion sheet used for uniformly diffusing the light emitted from the light source.

It should be pointed out that the structure of sidewalls of the present frame is not limited to the illustrated embodiment. The present frame may be integrally manufactured, the first sidewalls and second sidewalls thereof extending from the peripheral of the base to define an opening, should be considered to be within the scope of the present invention.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A bottom lighting type backlight module comprising:
a frame having a base and a plurality of sidewalls extending from the peripheral of the base to define an opening, wherein the base defines a plurality of first guide holes therein;
at least one optical sheet disposed on the opening of the frame, the optical sheet and the frame collectively defining a chamber;
a reflecting sheet supported by the sidewalls, for partitioning the chamber into an illumination space and a heat dissipation space, above and below the reflective sheet respectively, wherein the reflecting sheet defines a plurality of through holes therein; and
a plurality of light sources arranged on the base of the frame under the reflecting sheet corresponding to the through holes, illuminating light through the through holes towards the optical sheet.

2. The bottom lighting type backlight module according to claim 1, wherein the sidewalls include two opposite first sidewalls and two opposite second sidewalls, the base and the two first sidewalls are integrally formed, and the two second sidewalls are securely connected to the ends of the two first sidewalls and the base correspondingly.

3. The bottom lighting type backlight module according to claim 2, wherein each second sidewall is substantially in the form of a rectangular sheet, each second sidewall defining a protrusion portion extending from a portion beyond the bottom thereof toward an inner area of the frame, used for supporting the reflecting sheet.

4. The bottom lighting type backlight module according to claim 3, wherein each second sidewall defines a plurality of second guide holes at a portion therein above the protrusion portion.

5. The bottom lighting type backlight module according to claim 2, wherein the two second sidewalls are securely connected with the ends of the two first sidewalls and the base by a number of screws wherein.

6. The bottom lighting type backlight module according to claim 2, wherein an/the outer surfaces of the first sidewalls and bottom surface of the base define a plurality of fins extending out from thereon, parallel to each other.

7. The bottom lighting type backlight module according to claim 1, wherein the light sources are light emitting diodes.

8. The bottom lighting type backlight module according to claim 7, wherein the light emitting diodes are attached to the base of the frame by a number of screws in a matrix manner.

9. The bottom lighting type backlight module according to claim 1, wherein the at least one optical sheet consist of a light diffusion plate.

10. The bottom lighting type backlight module according to claim 9, further comprising a prism sheet disposed on the light diffusion plate.

11. The bottom lighting type backlight module according to claim 10, further comprising a brightness enhancement film disposed on the prism sheet.

12. The bottom lighting type backlight module according to claim 1, wherein a material of the frame is selected from a group comprising copper, aluminium and engineering plastic.

13. The bottom lighting type backlight module according to claim 1, further comprising a plurality of reflecting sidewalls extending from the periphery of the reflecting sheet, and tops of the four reflecting sidewalls are in contact with the optical sheet.

14. The bottom lighting type backlight module according to claim 1, further comprising a receiving frame fixed at the top of the frame for receiving the optical sheets, the receiving frame having a frame body, a rim portion extending from a bottom of the frame body running perpendicularly around an inside of the receiving frame.

15. The bottom lighting type backlight module according to claim 2, further comprising a supporting plate fixed on the protrusions of the second sidewalls of the frame, the supporting plate defining a plurality of holes therein according to the through holes of the reflecting sheet.

16. A bottom lighting type backlight module comprising:
a frame including a base;
at least one optical sheet separate from the base whereby a space is formed between the at least one optical sheet and the base;
a plurality of light sources attached to the base and configured for emitting light so as to illuminate the optical sheet, each light source including a substrate portion mounted on the base and a light luminescent portion extending from the substrate portion for emitting the light; and
a partition sheet positioned between the base and the optical sheet in a manner so as to partition said space into an illumination space between the optical sheet and the partition sheet, and a heat dissipation space between the base and the partition sheet wherein the substrate portions are located in the heat dissipation space, the light luminescent portions are located in the illumination space, and the heat dissipation space and the illumination space are not in communication with each other.

17. The bottom lighting type backlight module of claim 16, wherein the partition sheet includes a base wall and sidewalls extending from the base wall, the sidewalls hermetically connect to the optical sheet so as to close the illumination space.

18. The bottom lighting type backlight module of claim 16, wherein the frame includes sidewalls extending from the base, guiding holes are formed through at least one of the base and sidewalls, communicating the heat dissipation space with exterior space.

19. The bottom lighting type backlight module of claim 18, wherein the frame includes a plurality of fins on an outer surface thereof.

20. A bottom lighting type backlight module comprising:
a base;
at least one optical sheet separate from the base whereby a space is formed between the at least one optical sheet and the base;
at least one light source positioned in said space and configured for emitting light so as to illuminate the at least one optical sheet, each light source including a heat generating portion, and a light luminescent portion extending from the heat generating portion for emitting the light; and
a partition sheet positioned between the base and the optical sheet in a manner so as to partition said space into an illumination space between the optical sheet and the partition sheet, and a heat dissipation space between the base and the partition sheet wherein the illumination space is a closed space, the heat dissipation space is an open space in communication with an exterior thereof, the partition sheet having at least one through hole, the light source being received in the through hole with the light luminescent portion communicating with the illumination space and the heat generating portion communicating with the heat dissipation space.
